(19) United States
(12) Patent Application Publication
(10) Pub. No.: US 2021/0081026 A1
(43) Pub. Date: Mar. 18, 2021

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventors: Shungo NAKAYAMA, Kanagawa (JP); Akiyoshi OSUGI, Kanagawa (JP)

(73) Assignee: FUJI XEROX CO., LTD., Tokyo (JP)

(21) Appl. No.: 16/734,391

(22) Filed: Jan. 5, 2020

(30) Foreign Application Priority Data
Sep. 18, 2019 (JP) 2019-169406

(51) Int. Cl. G06F 1/3287; G06F 1/3234; G06F 1/3225; G06F 3/06

(52) U.S. Cl. CPC G06F 1/3287; G06F 1/3275; G06F 3/0673; G06F 3/0625; G06F 3/0653; G06F 1/3225

(57) ABSTRACT

An information processing apparatus includes a solid-state drive and a processor configured to perform a process to resume supplying power to the solid-state drive after an elapse of a waiting time period if a request to resume supplying power to the solid-state drive is received within a rated time period from a start of a power shutoff to the solid-state drive.

### CROSS-REFERENCE TO RELATED APPLICATIONS

This application is based on and claims priority under 35 USC 119 from Japanese Patent Application No. 2019-169406 filed Sep. 18, 2019.

### BACKGROUND

### (i) Technical Field

The present disclosure relates to an information processing apparatus and a non-transitory computer readable medium.

### (ii) Related Art

Some related-art information processing apparatuses have two operation modes, namely, a normal mode and power-saving mode. In the normal mode, power is supplied to each element in the information processing apparatus. In the power-saving mode, minimum power used to shift back to the normal mode is supplied to a controller and power to the remaining elements is shut off.

Japanese Unexamined Patent Application Publication No. 2004-54560 discloses an information processing apparatus having the normal mode and power-saving mode. If a request to shift from the normal mode to the power-saving mode and a request to shift from the power-saving mode to the normal mode are received simultaneously, the information processing apparatus introduces a time difference between execution timings of the two modes.

Solid-state drives (SSD) are occasionally used as a memory for the information processing apparatus having the normal mode and power-saving mode. Specifications of typical SSDs specify that supplying power to the SSDs is not to resume for a rated time period from the start of the power shutoff. If the power is shut off to the SSD, an operation to delete a cache buffer in the SSD or an operation to update a mapping table that contains information on data structure and that is referenced at a startup is performed in preparation for subsequent power supplying (namely, startup of the SSD). Resuming supplying power in the middle of each of the operations may adversely affect the SSD, for example, may reduce the life of the SSD.

When the condition to shift to the power-saving mode is satisfied, power to the SSD may be shut up in the information processing apparatus. If the request to resume supplying power to the SSD is placed within the rated time period with the condition to shift to the normal mode satisfied, supplying power to the SSD naturally resumes within the rated time period from the power shutoff to the SSD.

### SUMMARY

Aspects of non-limiting embodiments of the present disclosure relate to resuming supplying power to the SSD after the elapse of the rated time period from the power shutoff even if a request to resume supplying power to the SSD within the rated time period from the power shutoff to the SSD.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a solid-state drive and a processor. The processor is configured to perform a process to resume supplying power to the solid-state drive after an elapse of a waiting time period if a request to resume supplying power to the solid-state drive is received within a rated time period from a start of a power shutoff to the solid-state drive.

### BRIEF DESCRIPTION OF THE DRAWINGS

Exemplary embodiment of the present disclosure will be described in detail based on the following figures, wherein:

FIG. 1 illustrates a configuration of an information processing apparatus of the exemplary embodiment;

FIG. 2 is a flowchart illustrating a first process of the information processing apparatus of the exemplary embodiment; and

FIG. 3 is a flowchart illustrating a second process of the information processing apparatus of the exemplary embodiment.

### DETAILED DESCRIPTION

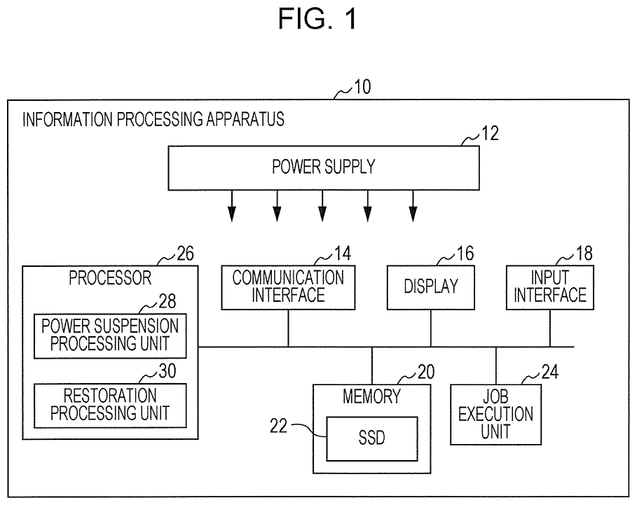

FIG. 1 illustrates a configuration of an information processing apparatus 10 of the exemplary embodiment. In accordance with the exemplary embodiment, the information processing apparatus 10 is an image processing apparatus. The image processing apparatus has a scanning function to optically read a recording medium to generate image data, a copy function to print image data scanned, a print function to print, onto a recording medium, image data specified by a user, and a fax function to transmit data specified by the user to a specified destination. The information processing apparatus 10 is not limited to the image processing apparatus and may be another apparatus, such as a personal computer.

A power supply 12 includes an alternating current (AC) to direct current (DC) converter, rectifier, and DC to DC converter. The power supply 12 supplies power to each element in the information processing apparatus 10. In response to an instruction from a processor 26 described below, the power supply 12 switches between supplying power to or shutting off power to each element in the information processing apparatus 10.

A communication interface 14 includes a wired or wireless local-area network (LAN) adaptor. The communication interface 14 has a function to communicate with another apparatus via a communication network, such as a LAN and/or the Internet. For example, the communication interface 14 receives a job as a process request from the other apparatus operated by a user.

A display 16 includes a liquid-crystal display. The display 16 displays a variety of information to the user of the information processing apparatus 10.

An input interface 18 includes a touch panel and a variety of buttons. If the information processing apparatus 10 is a personal computer, the input interface 18 may include a mouse and keyboard. The input interface 18 is used to receive an input to the information processing apparatus 10 from a user.

A memory 20 includes a hard disk, read-only memory (ROM), and random-access memory (RAM). Referring to FIG. 1, the memory 20 includes a solid-state drive (SSD) 22. As previously described, the specifications of the SSD 22 specify that supplying power to the SSD 22 should not resume within a rated time period (for example, 1 second) from a power shutoff. The memory 20 may be arranged external to the processor 26 described below, and part of the memory 20, such as the ROM or RAM, may be arranged within the processor 26. The memory 20 stores an information processing program causing each element in the information processing apparatus 10 to operate.

A job execution unit 24 performs an operation related to a job input to the information processing apparatus 10. For example, the job execution unit 24 includes a printer or a scanner. The scanner includes a transparent document platen, light source, and image sensor. The scanner optically reads a paper document placed on the document platen by the user and generates a digital document as target date corresponding to the paper document. The printer includes a paper transport mechanism, photoconductor drum, and cartridge and prints image data onto a recording medium.

The processor 26 is a processing apparatus in a broad sense. The processor 26 includes a general-purpose processor (such as central processing unit (CPU) and at least one of dedicated processors (such as graphic processing unit (GPU), application specific integrated circuit (ASIC), field programmable gate array (FPGA) and programmable logic device). The processor 26 may be one processor or plural processors in collaboration which are located physically apart from each other but may work cooperatively.

The information processing apparatus 10 has a normal mode and power-saving mode as operation modes. In the normal mode, the power supply 12 supplies power to each of elements in the information processing apparatus 10. In the power-saving mode, minimum power used to shift back to the normal mode is supplied to the processor 26 and the power supply 12 shuts off power to the remaining elements in the information processing apparatus 10. The processor 26 performs a mode switching operation, for example, an operation to shift from the normal mode to the power-saving mode and an operation to shift from the power-saving mode to the normal mode.

The processor 26 implements the function of a power suspension processor 28 and restoration processor 30 by working in concert with an information processing program stored on the memory 20.

If the condition to shift to the power-saving mode is satisfied with the information processing apparatus 10 in the normal mode, the power suspension processor 28 performs a shift operation to the power-saving mode (referred to as a power shut-off operation in the specification). For example, the shift condition to the power-saving mode is that the information processing apparatus 10 has not been operated for a predetermined period of time. Specifically, the input interface 18 has not been operated by the user for the predetermined period of time or the communication interface 14 has not received a job for the predetermined period of time. The information processing apparatus 10 may be shifted from the normal mode to the power-saving mode in response to a user instruction. In such a case, the shift condition is that the user has input a shift instruction to the power-saving mode.

As described above, in the power-saving mode, the minimum power used to shift back to the normal mode is supplied to the processor 26 while the power supply 12 shuts off power to the remaining elements in the information processing apparatus 10. The power suspension processor 28 transmits a shutoff signal to the power supply 12 in the power shut-off operation and thus shuts off power to the elements in the information processing apparatus 10 while still supplying the minimum power to the processor 26.

The power suspension processor 28 successively shuts off power to the elements in the information processing apparatus 10. For example, the power suspension processor 28 first shuts off power to a scanner in the job execution unit 24, then successively power to a printer in the job execution unit 24, power to the SSD 22, and finally power to an HDD in the memory 20. In accordance with the exemplary embodiment, a control target is the power supplied to the SSD 22. In a power suspension process performed by the power suspension processor 28, power to the SSD 22 is shut off first or in the middle of successive power shutoff operations to the elements in the information processing apparatus 10. Specifically, in the power suspension process, the power shutoff operations to the elements continue ever after power to the SSD 22 is shut off.

If the power suspension process is complete, the information processing apparatus 10 shifts to the power-saving mode.

The power suspension processor 28 desirably stores a shutoff time at which power to the SSD 22 is shut off in the power suspension process. Any method to store the shutoff time may be used. For example, at the timing when the power suspension processor 28 shuts off power to the SSD 22, the power suspension processor 28 generates a file storing generation time as attribute information and stores the file on the memory 20. In this case, the generation time of the file is the shutoff time. If the processor 26 has a time measurement function, the power suspension processor 28 may acquire, via the time measurement function, time at which power to the SSD 22 is shut off.

If the information processing apparatus 10 is in the power-saving mode as the operation mode or if the shift condition to the normal mode is satisfied in the middle of the power suspension process performed by the power suspension processor 28, the restoration processor 30 performs the shift operation to the normal mode (this shift operation is also referred to as a restoration process). For example, the shift condition to the normal mode is that the input interface 18 has been operated by the user or that the communication interface 14 has received a job.

In the normal mode, as described above, the power supply 12 supplies power to the elements in the information processing apparatus 10. In the restoration process, the restoration processor 30 causes the power supply 12 to resume supplying power to the elements by transmitting a supply signal to the power supply 12.

When the restoration process is complete, the information processing apparatus 10 shifts to the normal mode.

The shift condition to the normal mode may be satisfied within the rated time period specified in the specifications of the SSD 22 from the shutoff of power to the SSD 22 in the power suspension process. Supplying power to the SSD 22 resumes in the restoration process. The shift condition to the normal mode satisfied after the power shutoff to the SSD 22 in the power suspension process means that the restoration processor 30 has received a request to start supplying power to the SSD 22. If the restoration processor 30 immediately resumes supplying power to the SSD 22, this action does not meet the specifications of the SSD 22.

In accordance with the exemplary embodiment, the information processing apparatus 10 is an image processing apparatus that may be directly operated by the user and may receive a job transmitted from a remote apparatus via a communication network. The user who transmits a job using the remote apparatus has difficulty in learning the status of the information processing apparatus 10. Specifically, the information processing apparatus 10 may possibly receive the job in the middle of the power suspension process, namely, at the timing when a predetermined time period has elapsed with the information processing apparatus 10 not operating or at the timing when an instruction to shift to the power-saving mode has been input by the user. If the information processing apparatus 10 is the image processing apparatus, the shift condition to the normal mode may be satisfied within the rated time specified in the specifications of the SSD 22 from the power shutoff to the SSD 22.

If the shift condition to the normal mode is satisfied within the rated time from the power shutoff to the SSD 22, namely, if the request to start supplying power to the SSD 22 is received, the restoration processor 30 resumes supplying power to the SSD 22 after a waiting time.

The waiting time may have any time length as long as supplying power to the SSD 22 resumes after the elapse of the rated time from the power shutoff to the SSD 22. For example, the waiting time may be the rated time specified in the specifications of the SSD 22. In this case, if the request to start supplying power to the SSD 22 is received within the rated time from the power shutoff to the SSD 22, the restoration processor 30 automatically resumes supplying power to the SSD 22 after the elapse of the waiting time. The waiting time may be longer than the rated time specified in the specifications of the SSD 22.

If the waiting time is too long, the timing of resuming supplying power to the SSD 22 may be delayed, the restoration process may take time and the shifting to the normal mode may be delayed. If a time difference between the shutoff time at which power to the SSD 22 is shut off and stored in the power suspension processor 28 and the present time when the request to start supplying power to the SSD 22 is received is less than the rated time, a time period resulting from subtracting the time difference from the rated time is set to be the waiting time. In this way, supplying power to the SSD 22 may resume after the elapse of the rated time from the shutoff time. If the time difference between the shutoff time and the present time is the rated time or longer, the restoration processor 30 may immediately resume supplying power to the SSD 22.

The user may determine in a user setting as to which of the waiting times to select.

As described above, the power suspension processor 28 successively shuts off power to the elements in the power suspension process. If the request to start supplying power to the SSD 22 is received within the rated time from the power shutoff to the SSD 22 in the power suspension process, the power suspension processor 28 discontinues the power suspension process in the middle thereof. Specifically, the power suspension processor 28 does not thereafter shut off power to the elements. The restoration processor 30 then resumes supplying power to the SSD 22 after the elapse of the waiting time. The specifications of the SSD 22 are thus observed while the shifting to the normal mode is more quickly performed than when the restoration process is performed after the power suspension process is complete

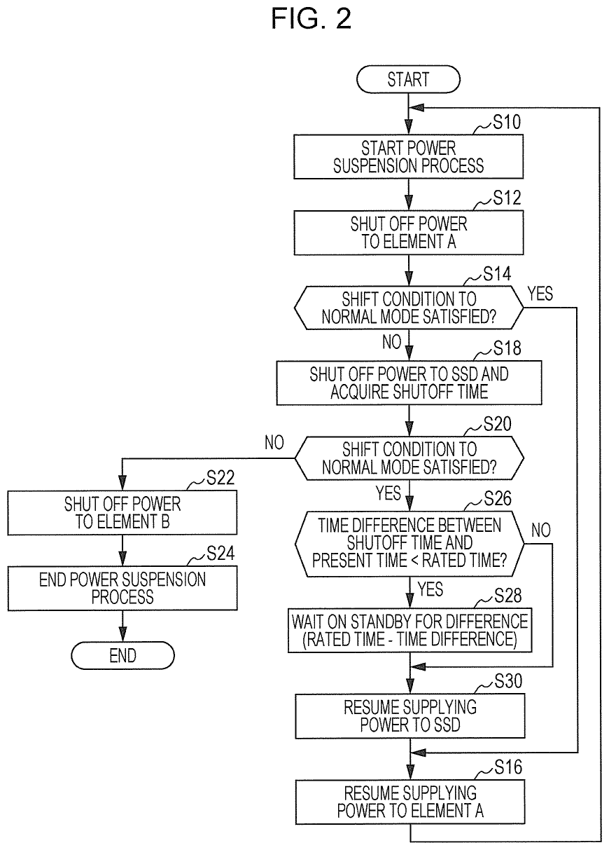

A first process of the information processing apparatus 10 is described with reference to a flowchart in FIG. 2. The information processing apparatus 10 is in the normal mode at the beginning of the first process in FIG. 2.

In step S10, the power suspension processor 28 starts the power suspension process if the shift condition to the normal mode is satisfied.

In step S12, the power suspension processor 28 shuts off power to element A representing one or more units other than the SSD 22 in the information processing apparatus 10.

In step S14, the restoration processor 30 determines whether the shift condition to the normal mode is satisfied. If the shift condition to the normal mode is satisfied, the power suspension processor 28 discontinues the power suspension process and proceeds to step S16.

In step S16, the restoration processor 30 starts the restoration process. In this case, the restoration processor 30 resumes supplying power to the element A to which power is shut off in step S10.

If the shift condition to the normal mode is not satisfied in step S14, processing proceeds to step S18.

In step S18, the power suspension processor 28 shuts off power to the SSD 22. The power suspension processor 28 also acquires and stores the shutoff time at which power to the SSD 22 is shut off.

In step S20, the restoration processor 30 determines whether the shift condition to the normal mode is satisfied. If the shift condition to the normal mode is not satisfied, processing proceeds to step S22.

In step S22, the power suspension processor 28 shuts off power to an element B other than the SSD 22 and the element A in the information processing apparatus 10. In step S24, the power suspension processor 28 ends the power suspension process. If the shift condition to the normal mode is satisfied subsequent to step S24, the restoration processor 30 performs the restoration process.

If the shift condition to the normal mode is satisfied in step S20, processing proceeds to step S26.

In step S26, the restoration processor 30 determines whether the time difference between the shutoff time acquired by the power suspension processor 28 in step S18 and the present time when the shift condition to the normal mode is satisfied, namely, the request to start supplying power to the SSD 22 is received is less than the rated time specified in the specifications of the SSD 22.

If the time difference is less than the rated time, the restoration processor 30 waits in step S28 for the waiting time that results from subtracting the time difference from the rated time. In step S30, the restoration processor 30 resumes supplying power to the SSD 22.

If the restoration processor 30 determines in step S26 that the time difference is equal to or longer than the rated time, the restoration processor 30 proceeds to step S30, skipping step S28. Specifically, the restoration processor 30 resumes supplying power to the SSD 22 without waiting. The restoration processor 30 then completes the restoration process by returning to step S16 to resume supplying power to the element A.

If the shift condition to the normal mode is satisfied subsequent to step S22, processing may proceed to step S26. The power suspension process may be performed fast. If the shift condition to the normal mode is satisfied subsequent to step S22, the time difference between the shutoff time acquired by the power suspension processor 28 and the present time when the shift condition to the normal mode is satisfied may possibly be less than the rated time specified in the specifications of the SSD 22.

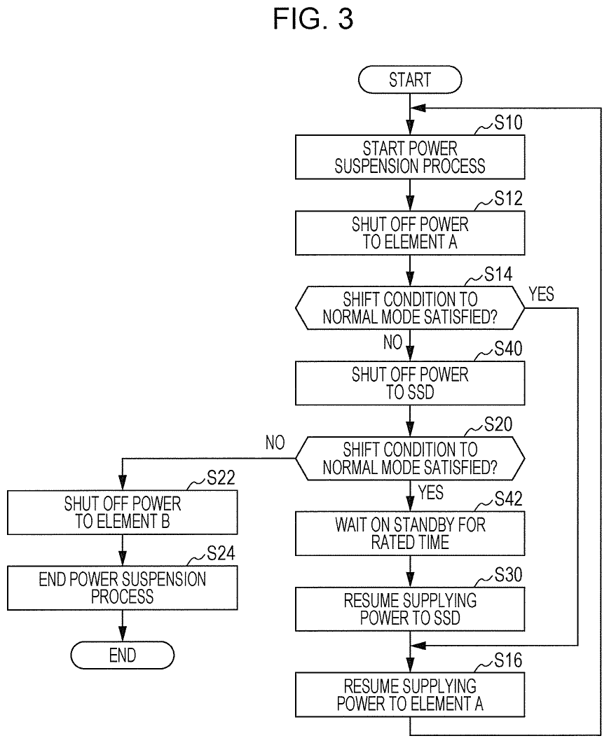

A second process of the information processing apparatus 10 is described with reference to a flowchart in FIG. 3. In the first process in FIG. 2, if the request to start supplying power to the SSD 22 is received within the rated time from the power shutoff to the SSD 22, the restoration processor 30 waits on standby for the time resulting from subtracting the time difference between the shutoff time and the present time from the rated time and then resumes supplying power to the SSD 22. In the second process in FIG. 3, if the request to start supplying power to the SSD 22 is received within the rated time from the power shutoff to the SSD 22, the restoration processor 30 automatically waits on standby for the rated time and then resumes supplying power to the SSD 22. In the flowchart in FIG. 3, the operation in step S18 in FIG. 2 is an operation in step S40 and the operations in step S26 and S28 in FIG. 2 are an operation in step S42. The operations in other steps are designated with the same step numbers as in FIG. 2 and the discussion thereof is omitted herein.

In step S40, the power suspension processor 28 shuts off power to the SSD 22. In step S18 in FIG. 2, the power suspension processor 28 acquires and stores the shutoff time at which power to the SSD 22 is shut off. In the second process in FIG. 3, the shutoff time is not stored.

If the shift condition to the normal mode is satisfied in step S20 after power to the SSD 22 is shut off in step S40, namely, if the request to start supplying power to the SSD 22 is received after power to the SSD 22 is shut off in step S40, the restoration processor 30 waits on standby in step S42 for the rated time specified in the specifications of the SSD 22. In step S30, the restoration processor 30 resumes supplying power to the SSD 22.

In the exemplary embodiment above, the term “processor” refers to hardware in a broad sense. Examples of the processor includes general processors (e.g., CPU: Central Processing Unit), dedicated processors (e.g., GPU: Graphics Processing Unit, ASIC: Application Specific Integrated Circuit, FPGA: Field Programmable Gate Array, and programmable logic device).

In the exemplary embodiment above, the term “processor” is broad enough to encompass one processor or plural processors in collaboration which are located physically apart from each other but may work cooperatively. The order of operations of the processor is not limited to one described in the exemplary embodiment above, and may be changed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a solid-state drive; and
a processor configured to perform a process to resume supplying power to the solid-state drive after an elapse of a waiting time period if a request to resume supplying power to the solid-state drive is received within a rated time period from a start of a power shutoff to the solid-state drive.

2. The information processing apparatus according to claim 1, wherein if a time difference between a shutoff time at which power to the solid-state drive is shut off and present time at which the request to resume supplying power is received is less than the rated time period, the processor sets, as the waiting time period, a difference resulting from subtracting the time difference from the rated time period.

3. The information processing apparatus according to claim 1, wherein the waiting time period equals the rated time period.

4. The information processing apparatus according to claim 1, wherein power to the solid-state drive is shut off in a middle of successive shutoffs of power to units in the information processing apparatus, and
wherein if the request to resume supplying power to the solid-state drive is received, the processor performs a process to discontinue power shutoff and to resume supplying power to the solid-state drive after the elapse of the waiting time period.

5. The information processing apparatus according to claim 2, wherein power to the solid-state drive is shut off in a middle of successive shutoffs of power to units in the information processing apparatus, and
wherein if the request to resume supplying power to the solid-state drive is received, the processor performs a process to discontinue power shutoff and to resume supplying power to the solid-state drive after the elapse of the waiting time period.

6. The information processing apparatus according to claim 3, wherein power to the solid-state drive is shut off in a middle of successive shutoffs of power to units in the information processing apparatus, and
wherein if the request to resume supplying power to the solid-state drive is received, the processor performs a process to discontinue power shutoff and to resume supplying power to the solid-state drive after the elapse of the waiting time period.

7. A non-transitory computer readable medium storing a program causing a computer to execute a process for processing information, the process comprising performing a process to resume supplying power to a solid-state drive after an elapse of a waiting time period if a request to resume supplying power to the solid-state drive is received within a rated time period from a start of a power shutoff to the solid-state drive.

8. An information processing apparatus comprising:
memory means; and
power control means for resuming power supply to the memory means after an elapse of a waiting time period if a request to resume power supply to the memory means is received within a rated time period from a start of a power shutoff to the memory means.
